(19) United States
(12) Patent Application Publication
(10) Pub. No.: US 2025/0256646 A1
(43) Pub. Date: Aug. 14, 2025

(54) VEHICULAR LIGHTING DEVICE

(71) Applicants: TOYOTA BOSHOKU KABUSHIKI KAISHA, Aichi-ken (JP); TOYOTA JIDOSHA KABUSHIKI KAISHA, Aichi-ken (JP)

(72) Inventors: Narimatsu TETSUYA, Aichi-ken (JP); Isao SAKAUE, Aichi-ken (JP); Ippei KOBAYASHI, Aichi-ken (JP)

(73) Assignees: TOYOTA BOSHOKU KABUSHIKI KAISHA, Aichi-ken (JP); TOYOTA JIDOSHA KABUSHIKI KAISHA, Aichi-ken (JP)

(21) Appl. No.: 19/027,832

(22) Filed: Jan. 17, 2025

(30) Foreign Application Priority Data
Feb. 13, 2024 (JP) 2024-019605

(51) Int. Cl. B60Q 3/217; B60Q 3/62; B60Q 3/78; H05B 45/10; H05B 47/16

(52) U.S. Cl. CPC B60Q 3/217; B60Q 3/62; H05B 45/10; H05B 47/16; B60Q 3/78

(57) ABSTRACT

A vehicular lighting device mounted on an interior component including upper and lower plate members includes LEDs arranged on the vehicular exterior side with respect to the upper plate member and supplying light to a vehicular interior space through a clearance between the upper and lower plate members, a light transmissive member through which light from the LEDs passes toward the vehicular interior space and that includes recessed portions on a plate surface facing the LEDs, and a controller. The LEDs are defined into LED sets each of which includes at least two LEDs arranged at a first interval in the vehicular front-rear direction and the LED sets are arranged in the vehicular front-rear direction at a second interval that is greater than the first interval. The controller is configured to turn on the at least two LEDs included in one of the LED sets at different timings.

### CROSS REFERENCE TO RELATED APPLICATION

This application claims priority from Japanese Patent Application No. 2024-19605 filed on Feb. 13, 2024. The entire contents of the priority application are incorporated herein by reference.

### TECHNICAL FIELD

The present technology described herein relates to a vehicular lighting device.

### BACKGROUND

There have been a lighting device and a lighting structure mounted on a vehicular interior component. In one example of such a lighting structure, multiple LEDs are arranged on a back side of the door trim of a vehicle and light from the LEDs exits through light ejection slits in the door trim. Thus, linear light is supplied to a vehicular interior space.

In another example, a light guide plate, which is configured as a light emitter, is mounted on a vehicular exterior side of the trim body that has light transmissive properties. Light that exits the light guide plate is supplied to the trim body from a back surface side such that a design pattern appears on a front surface of the trim body.

### SUMMARY

Recently, improvement of the vehicular interior design has been highly demanded and a wide variety of lighting patterns is demanded.

An object of the present technology described herein is to provide a vehicular lighting device that improves a vehicular interior design.

The technology described herein is related to a vehicular lighting device to be mounted on an interior component that includes an upper plate member extending in a vehicular front-rear direction and having an interior design surface and a lower plate member disposed below the upper plate member and on a vehicular exterior side with respect to the upper plate member. The vehicular lighting device includes LEDs arranged on the vehicular exterior side with respect to the upper plate member, a light transmissive member that is disposed between a lower edge of the upper plate member and an upper edge of the lower plate member and has a plate shape having a plate surface extending in a vehicular interior-exterior direction, and a controller. The LEDs are defined into LED sets each of which includes at least two LEDs arranged at a first interval in the vehicular front-rear direction and the LED sets are arranged in the vehicular front-rear direction at a second interval that is greater than the first interval. The LEDs emit and supply light to a vehicular interior space. The light transmissive member includes recessed portions on the plate surface facing the LEDs and light from the LEDs passes through the light transmissive member toward the vehicular interior space. The controller is configured to turn on and off each of the LEDs separately and configured to turn on the at least two LEDs included in one of the LED sets at different timings.

### BRIEF DESCRIPTION OF THE DRAWINGS

FIG. 1 is a front view of a door trim of a front side door according to one embodiment.

FIG. 2 is a cross-sectional view along I-I line.

FIG. 3 is an enlarged plan view of a portion of an LED unit.

FIG. 4 is a perspective view illustrating the LED unit supplying light to a light transmissive plate.

FIG. 5 is a perspective view illustrating the LED unit, the light transmissive plate, and an armrest board.

FIG. 6 is an exploded perspective view illustrating a holding member and the light transmissive plate.

FIG. 7 illustrates one example of waveforms indicating chronological change of luminous intensity of two LEDs included in a LED set.

FIG. 8 illustrates another example of waveforms indicating chronological change of luminous intensity of two LEDs included in a LED set.

FIG. 9 illustrates other example of waveforms indicating chronological change of luminous intensity of two LEDs included in a LED set.

FIG. 10 illustrates other example of waveforms indicating chronological change of luminous intensity of two LEDs included in a LED set.

FIG. 11 illustrates one example of waveforms indicating chronological change of luminous intensity of three LEDs included in a LED set.

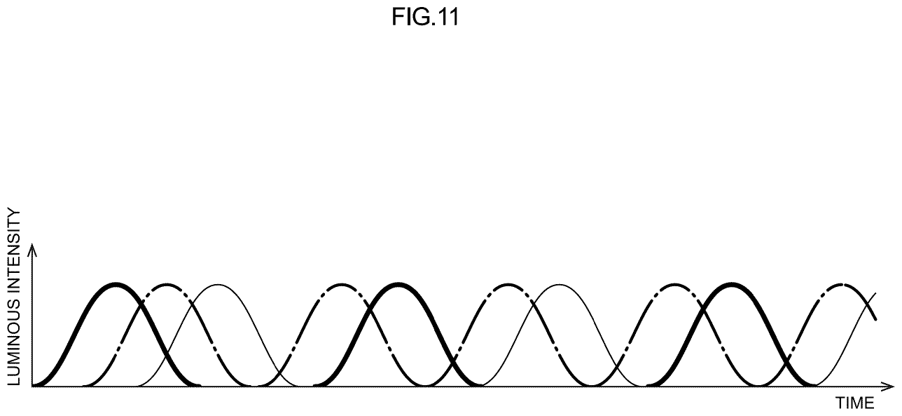

### DETAILED DESCRIPTION

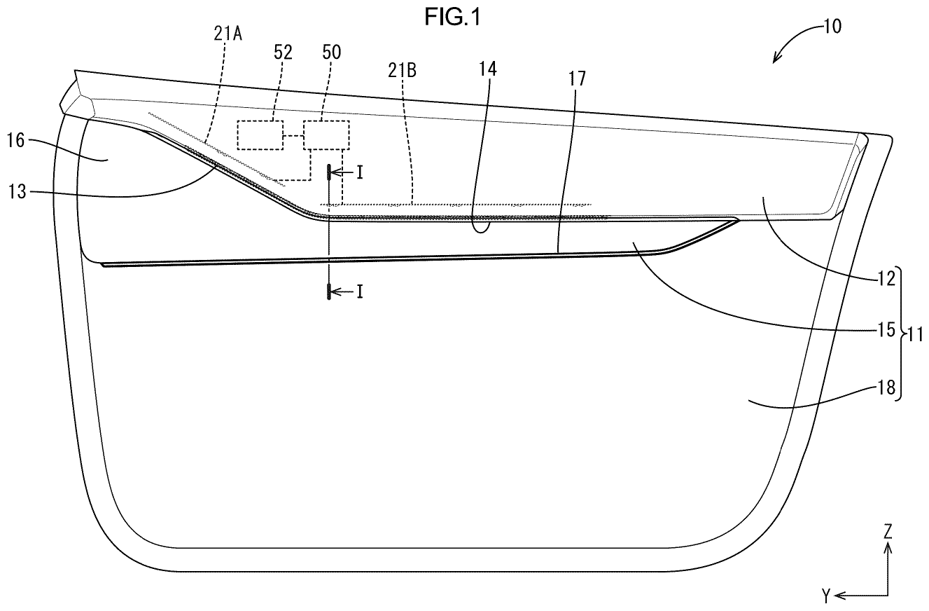

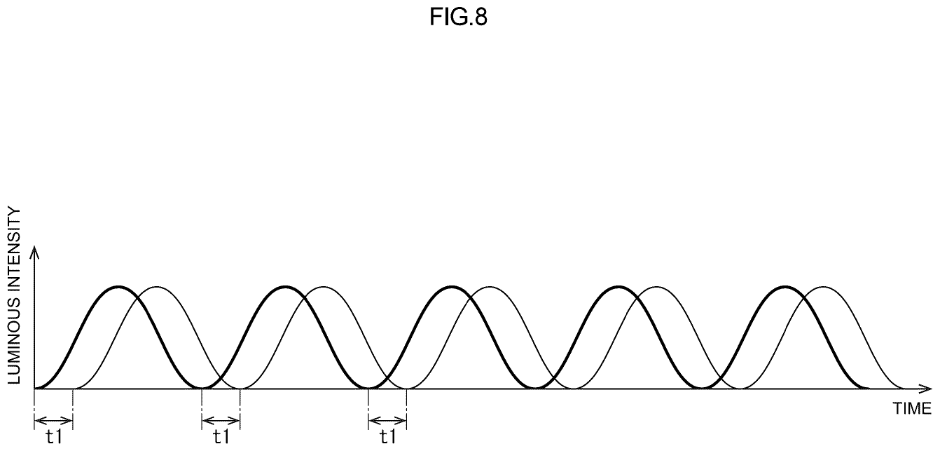

A vehicular lighting device according to one embodiment will be described with reference to FIGS. 1 to 8. A lighting device 20 that is mounted on a door trim 10 (one example of an interior component) for a vehicle such as an automobile will be described. An X-axis, a Y-axis, and a Z-axis may be present in each drawing and the axes in each drawing correspond to the respective axes in other drawings. The X-axis direction represents a right side or a vehicular exterior side and the Y-axis direction represents an upper side. The directions are not limited to those described in the drawings. One of the same components is represented by a reference symbol and others may not be represented by the reference symbol. A vehicular interior side surface of the door trim 10 corresponds to a vehicular front side surface.

FIG. 1 is an elevation view of the door trim 10 of a front right side door seen from a vehicular interior side. As illustrated in FIG. 1, the door trim 10 includes a trim board 11 having a plate shape as a main section. The door trim 10 is mounted on a door inner panel made of metal on a vehicular interior side with clips. Thus, the design and comfort of a vehicular interior are improved. The trim board 11 is made of synthetic resin material (thermoplastic resin material) such as polypropylene. The trim board 11 may be made of composite material obtained by mixing plant fibers (such as kenaf) and synthetic resin.

As illustrated in FIG. 1, the trim board 11 includes multiple board members that are joined together. The trim board 11 of this embodiment includes an upper board 12 (one example of an upper plate member), an armrest board 15 (one example of a lower plate member), and a lower board 18.

The upper board 12 is an upper section of the trim board 11 and has an elongated shape extending in a vehicular front-rear direction. The width of the upper board 12 decreases in a front section thereof such that a lower edge of the upper board 12 extends upward as it extends frontward. The lower edge of the front section of the upper board 12 is referred to as a slope portion 13. A rear section of the upper board 12 includes a lower edge that extends along an armrest 17 and the lower edge of the rear section of the upper board 12 is referred to as an opposed portion 14.

The upper board 12 including the slope portion 13 has a tapered shape such that the width decreases as it extends frontward. As illustrated in FIG. 1, in a front view, most portion of the lower edge of the upper board 12 is disposed adjacent to the armrest board 15 and a rear end portion of the lower edge of the upper board 12 is adjacent to the lower board 18.

The armrest board 15 is below and next to the upper board 12. The armrest board 15 has an elongated shape extending in the vehicular front-rear direction (Y-direction) and is shorter than the upper board 12.

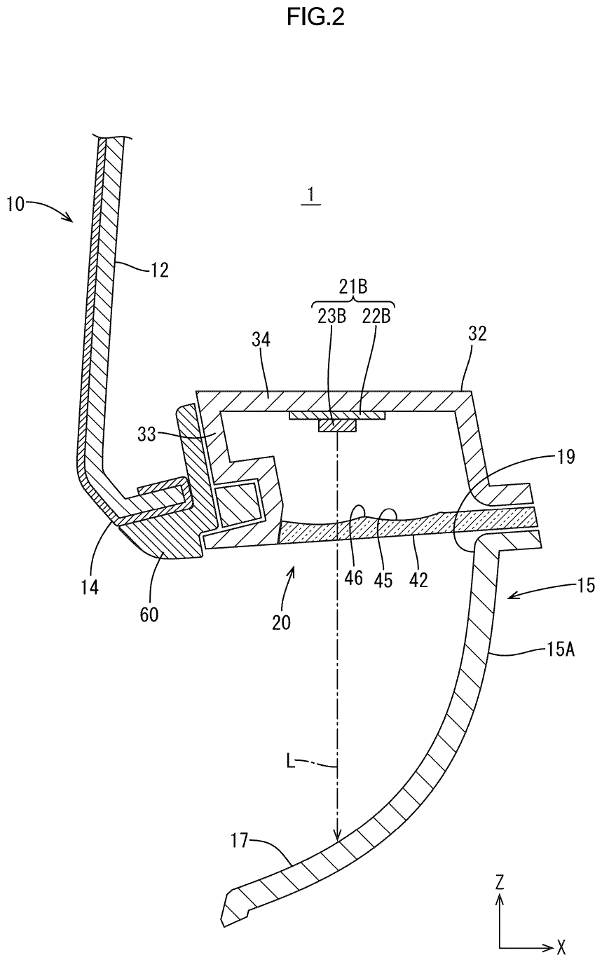

As illustrated in FIG. 2, the armrest board 15 includes a board body 15A and an armrest 17. The board body 15A is a wall portion that extends in the upper-bottom direction and the vehicular front-rear direction and faces the vehicular interior side. The armrest 17 is a lower section of the armrest board 15 and extends from a lower end of the board body 15A to the vehicular interior side. The armrest 17 extends to be curved toward the vehicular interior side as it extends downward from the board body 15A. As illustrated in FIG. 1, the armrest 17 extends along an entire length of the armrest board 15 in the vehicular front-rear direction.

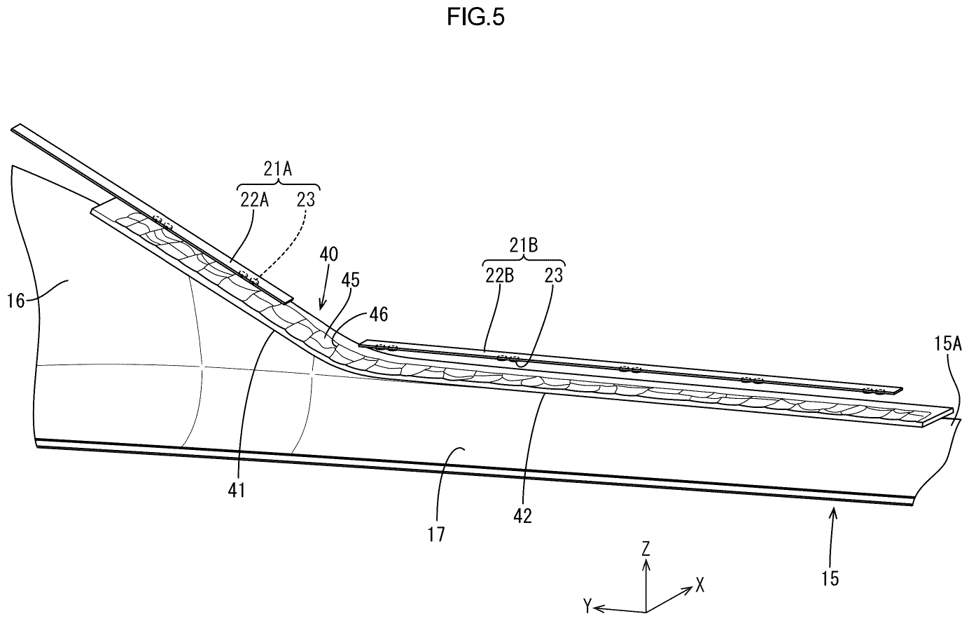

As illustrated in FIGS. 1 and 5, The front section of the board body 15A of the armrest board 15 is configured as a flat surface portion 16. The frat surface portion 16 is relatively above the armrest 17 and integrally extends upward from the armrest 17. With the upper board 12 including the slope portion 13 at the lower edge thereof, the flat surface portion 16 has a triangular plate shape that extends in the vehicular front-rear direction (the Y-direction) and the upper-bottom direction (the Z-direction). According to such a configuration, with the vehicular door being closed, right and left end portions of an instrumental panel, which is installed in a front section of the vehicle and protrudes toward the vehicular interior side, are fitted to the flat surface portions 16 as if the trim board 11 and the instrumental panel are configured as one component.

As illustrated in FIG. 2, the upper edge of the armrest board 15 is on a vehicular exterior side with respect to the lower edge of the upper board 12 in the vehicular interior-exterior direction (the X-direction). Namely, a slit 19 (one example of a clearance) is between the lower edge of the upper board 12 and the upper edge of the armrest board 15. The slit 19 has an elongated opening extending in the vehicular front-rear direction. The slit 19 extends from a front edge of the trim board 11 to a rear edge of the armrest board 15. The lighting device 20 is disposed above the silt 19 and light emitted by the lighting device 20 is supplied downward through the slit 19 to the door trim 10. The light from the lighting device 20 travels directly toward the slit 19 and is supplied to a light transmissive plate 40. The light transmissive plate 40 is disposed below the LEDs 23 and light emitting surfaces of the LEDs 23 face the light transmissive plate 40.

As illustrated in FIGS. 1, 2, 4, and 6, the lighting device 20 includes LED units including a first LED unit 21A and a second LED unit 21B, a holding member 30 holding the LED units, the light transmissive plate 40 (one example of a light transmissive member), and a controller 50. In this embodiment, as illustrated in FIGS. 1 and 5, the LED units include the first LED unit 21A that is mounted in a front section of the trim board 11 and the second LED unit 21B that is mounted in a rear section of the trim board 11.

The first LED unit 21A and the second LED unit 21B have a substantially same configuration. In the following, the second LED unit 21B will be described with reference to FIGS. 2 to 4. The second LED unit 21B includes a second board LED 22B having a long belt shape extending in the front-rear direction and the LEDs 23 that are arranged in the elongated direction on the second LED board 22B. As illustrated in FIG. 2, the second LED unit 21B is disposed on the vehicular exterior side of the lower edge of the upper board 12 with being arranged in the holding member 30 (a second holding portion 32). The LEDs 23 are arranged in a line along the lower edge of the upper board 12, which is along the vehicular front-rear direction (the Y-direction), as illustrated with a broken line in FIG. 1. The first LED unit 21A and the second LED unit 21B may differ in the length and the number of LEDs 23.

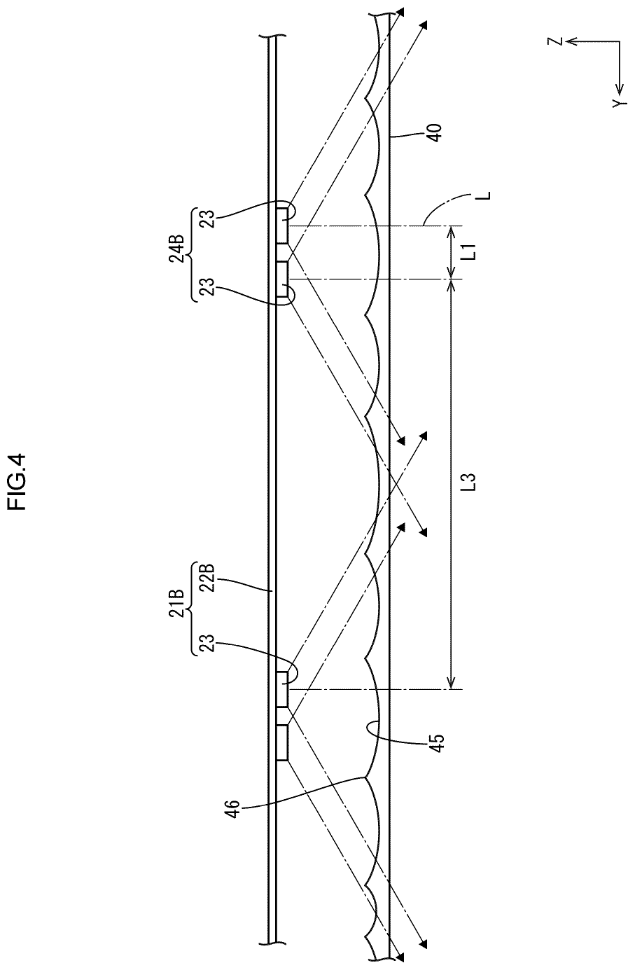

As illustrated in FIG. 4, the LEDs 23 are top surface LEDs and light emitted from a light emitting surface radially spreads three-dimensionally around an optical axis L within a certain angle range. The LEDs 23 of this embodiment have a directivity angle of 120 degrees. The directivity angle of the LEDs 23 is not limited to 120 degrees but may be other than 120 degrees.

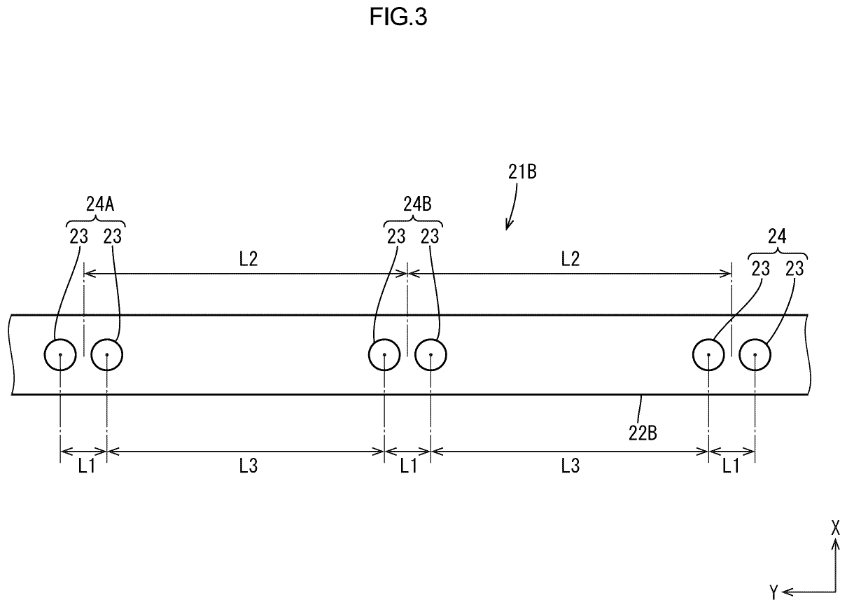

As illustrated in FIG. 3, on the second LED board 22B, multiple LED sets 24 are arranged in the elongated direction. Each LED set 24 includes two LEDs 23. Each LED set 24 may include three or more LEDs 23. The LED sets 24 include a first LED set 24A and a second LED set 24B that are adjacent to each other. The two LEDs 23 included in each of the first LED set 24A and the second LED set 24B are spaced with an interval L1. The interval between the first LED set 24A and the second LED set 24B is defined as L2. The LED sets 24, which include the first LED set 24A and the second LED set 24B, are arranged at intervals L2 in a line on the second LED board 22B. The interval L2 between the first LED set 24A and the second LED set 24B is determined such that the irradiation range of the LEDs 23 included in the first LED set 24A and the irradiation range of the LEDs 23 included in the second LED set 24B do not overlap when the light emitted by the LEDs 23 passes through the light transmissive plate 40. A distance between one of the two LEDs 23 included in the first LED set 24A and one of the two LEDs 23 included in the second LED set 24B that are closer to each other is defined as L3 (L3=L2−L1). The distance L3 is greater than the interval L1 (L3>L1). Namely, the distance L3 between the first LED set 24A and the second LED set 24B is greater than the interval L1 between the two LEDs 23 included in each of the first LED set 24A and the second LED set 24B.

As illustrated in FIG. 4, the interval L1 between the two LEDs 23 included in each of the first LED set 24A and the second LED set 24B is determined such that most of the irradiation ranges of the two LEDs 23 included each of the LED sets 24A and 24B overlap when the light emitted by the two LEDs 23 passes through the light transmissive plate 40. Most of the irrigation ranges of the two LEDs 23 on the light transmissive plate 40 overlap. The distance L3 between one of the LEDs 23 included in the first LED set 24A and one of the LEDs 23 included in the second LED set 24B is determined such that the irradiation range of the LED 23 included in the first LED set 24A and the irradiation range of the LED 23 included in the second LED set 24B do not overlap when the light emitted by the two LEDs 23 passes through the light transmissive plate 40. The distance L3 is preferably determined such that the light emitted by the LEDs 23 included in the first LED set 24A and the light emitted by the LEDs 23 included in the second LED set 24B cross after passing through the light transmissive plate 40. Namely, the irradiation ranges of the LEDs 23 included in the first LED set 24A and the irradiation ranges of the LEDs 23 included in the second LED set 24B preferably overlap near the vehicular interior surface (a lower surface in FIG. 4) of the light transmissive plate 40. According to such a configuration, the light rays emitted by the LEDs 23 included in the first LED set 24A and the light rays emitted by the LEDs 23 included in the second LED set 24B are less likely to have interference and a continuous optical design extending in the vehicular front-rear direction is provided.

The first LED board 22A, the second LED board 22B, and the LEDs 23 on each of the first LED board 22A and the second LED board 22B are electrically connected to a controller 50. The controller 50 is configured to control each of the LEDs 23 independently. With an operator selecting a lighting mode through an operation portion 52, which is electrically connected to the controller 50, the controller 50 receives a signal related to the selected lighting mode and is configured to control each of the LEDs 23 to be on and off or change luminous intensity according to the program stored in the controller 50.

In this embodiment, the first LED unit 21A on the front extends along the slope portion 13 of the upper board 12 and the second LED unit 21B on the rear extends along the opposed portion 14. Namely, the first LED board 22A of the first LED unit 21A slopes so as to extend upward (the Z-direction) with respect to the horizontal direction as it extends frontward. The first LED board 22A is disposed such that the lower surface thereof faces substantially frontward. The second LED board 22B of the second LED unit 21B is disposed such that plate surfaces thereof extend horizontally and face upward and downward, respectively.

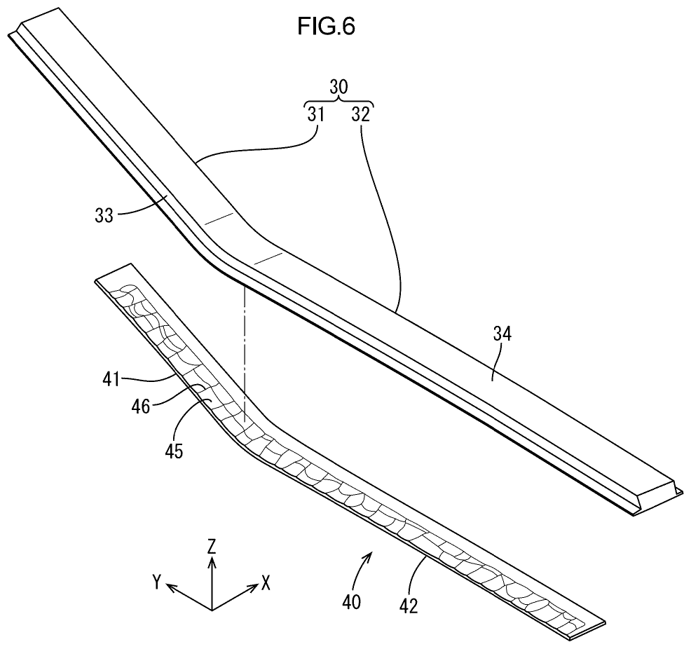

The first LED board 22A and the second LED board 22B are held by the holding member 30 in the determined posture. As illustrated in FIG. 6, the holding member 30 has a long box shape extending in the vehicular front-rear direction and opens downward. As illustrated in FIG. 2, a vehicular interior side wall portion 33 of the holding member 30 is fixed to the lower edge of the upper board 12 via a fixing member 60.

More specifically, as illustrated in FIG. 6, the holding member 30 includes a first holding portion 31 that extends along the slope portion 13 of the upper board 12 and the second holding portion 32 that extends along the opposed portion 14. The first holding portion 31 and the second holding portion 32 are integrally formed as the holding member 30 so as to be curved at an intermediate portion between the first holding portion 31 and the second holding portion 32. As illustrated in FIG. 2, the first LED board 22A is held on a lower surface of an upper wall portion 34 of the first holding portion 31 and the second LED board 22B is held on a lower surface of the upper wall portion 34 of the second holding portion 32. According to such a configuration, the LEDs 23 emit light downward.

As illustrated in FIG. 2, an opening of the holding member 30 is covered by the light transmissive plate 40 (one example of the light transmissive member). The light transmissive plate 40 is made of synthetic resin having high light transmissive properties (high transparency) such as acrylic, PET, polycarbonate. Light emitted by the LEDs 23 passes through the light transmissive plate 40.

As illustrated in FIG. 6, the light transmissive plate 40 has an elongated band shape and includes a first portion 41 that covers the opening of the first holding portion 31 and a second portion 42 that covers the opening of the second holding portion 32. The first portion 41 and the second portion 42 are integrally formed with and configured as the light transmissive plate 40 so as to be curved at an intermediate portion between the first portion 41 and the second portion 42. Thus, the light transmissive plate 40 has a substantially L-shape as a whole. As illustrated in FIG. 5, the second portion 42 has a plate surface that extends horizontally and parallel to the second LED board 22B. The first portion 41 slopes upward (the Z-direction) from a front end of the second portion 42 as it extends frontward and extends parallel to the first LED board 22A.

As illustrated in FIGS. 4 to 6, the light transmissive plate 40 includes recessed portions 45 (one example of a lens portion) having curved surfaces. The recessed portions 45 are recessed toward the vehicular interior side and have an arched cross-sectional shape having different size and height. The recessed portions 45 are formed at random and successively and has a surface of a waveform. Protrusion portions 46 protruding upward and having a top are formed in intermediate portions of the adjacent recessed portions 45.

As illustrated in FIG. 4, the recessed portions 45 are formed such that the optical axes L of the LEDs 23 held in the holding member 30 extend through the recessed portions 45 with the light transmissive plate 40 covering the opening of the holding member 30. One of the recessed portions 45 is formed to be in a position and have a size so as to face the two LEDs 23 included in the first LED set 24A or the second LED set 24B. Namely, the recessed portion 45 is formed to be in a position and have a size such that the optical axes L of the two LEDs 23 included in each of the first LED set 24A or the second LED set 24B pass through the recessed portion 45.

With such a configuration, the light rays emitted by the two LEDs 23 included in each of the first LED set 24A and the second LED set 24B are collected by the recessed portion 45 when passing the light transmissive plate 40 and exit the light transmissive plate 40 toward the vehicular interior space with being dispersed. Accordingly, a pattern corresponding to the recessed portions 45 and the protrusion portions 46 (the intermediate portions between the adjacent recessed portions 45) appears on the armrest board 15 and a bright and beautiful design can be provided.

Next, an operation of the lighting device 20 of this embodiment will be described. The controller 50 is configured to control the LEDs 23 to gradually increase the luminous intensity after turning on the LEDs 23 and thereafter gradually decrease the luminous intensity and turn off the LEDs 23. The controller 50 is configured to control the two LEDs 23 included in each of the first LED set 24A and the second LED set 24B to be turned on at different timings and have highest luminous intensity at different timings.

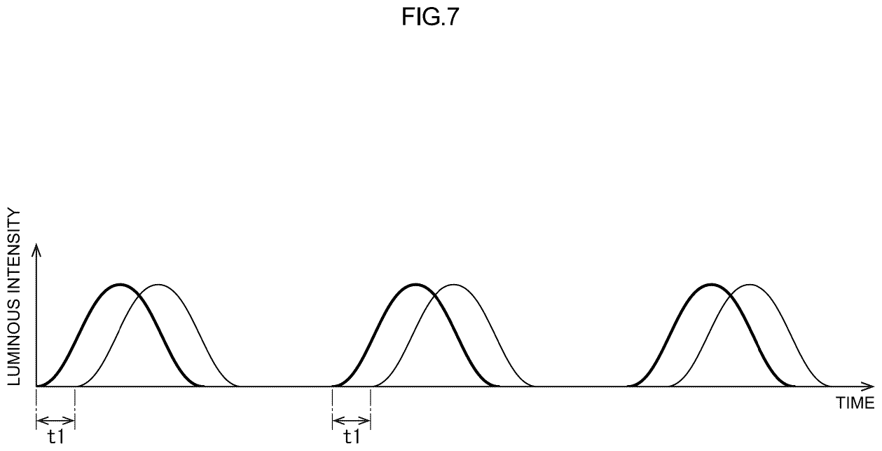

FIG. 7 illustrates a graph indicating a chronological change of the luminous intensity of the two LEDs 23 of the first LED set 24A, for example. According to the graph, the two LEDs 23 have the highest luminous intensity at different timings. In FIG. 7, a bold line indicates the chronological change of the luminous intensity of one of the two LEDs 23 and a thin line indicates the chronological change of the luminous intensity of other one of the two LEDs 23. For example, when a first lighting mode is selected by an operator via the operation portion 52 and the controller 50 receives a signal related to the first lighting mode, the controller 50 controls one of the two LEDs 23 of the first LED set 24A to be on, and after time t1 passes, the controller 50 controls other one of the two LEDs 23 of the first LED set 24A to be on. According to such an operation, as illustrated in FIG. 7, the luminous intensity of the LEDs 23 gradually increases after the LEDs 23 are turned on and after increasing to the highest level, the luminous intensity gradually decreases until the LEDs 23 are turned off. The waveforms of the luminous intensity of the two LEDs 23 are displaced from each other by the time t1. Namely, the two LEDs 23 are turned on at different timings. The two LEDs 23 are turned on with time difference t1. The controller 50 intermittently and repeatedly turns on the two LEDs 23 included in each LED set 24 at different timings. According to such a configuration, a flickering light image pattern like flickering flame and aurora is projected on the vehicular interior according to the recessed portions 45 of the light transmissive plate 40.

When a second lighting mode is selected by an operator via the operation portion 52 and the controller 50 receives a signal related to the second lighting mode, the controller 50 successively and repeatedly turns on one of the two LEDs 23 of the first LED set 24A and turns on other one of the two LEDs 23 after time t1 passes after turning on the one of the two LEDs 23. Every two LEDs 23 are turned on at different timings successively and repeatedly. The two LEDs 23 are turned on with time difference t1 and have the highest luminous intensity at different timings with the time difference t1. In the second lighting mode, a flickering light image pattern different from that in the first lighting mode can be obtained.

According to such a lighting operation of the lighting device 20, light is emitted by the LEDs 23 included in each LED set 24 at different timings. The luminous intensity of the light emitted by the LEDs 23 of each LED set 24 changes with time difference t1. Namely, the light emitted by the LEDs 23 of each LED set 24 has highest luminous intensity at different timings. Such light rays pass through the light transmissive plate 40 having the recessed portions 45 and the flickering light image is projected on the vehicular interior like flickering flame and aurora. The controller 50 is configured to simultaneously control the LED sets 24 such that the LEDs 23 of each LED set 24 are turned on at different timings.

Next, configurations, operations, and effects of this embodiment will be described. The lighting device 20 of this embodiment is mounted on the door trim 10 (the trim board 11) that includes the upper board 12 having an elongated shape extending in the vehicular front-rear direction and having an interior design surface and the armrest board 15 disposed below the upper board 12 and on the vehicular exterior side with respect to the upper board 12. The upper edge of the armrest board 15 is disposed on the vehicular exterior side with respect to the lower edge of the upper board 12. The lighting device 20 supplies light to the vehicular interior through the slit 19 between the upper board 12 and the armrest board 15. The lighting device 20 includes the light transmissive plate 40, the LEDs 23, and the controller 50. The light transmissive plate 40 includes the recessed portions 45 that are recessed on a plate surface facing the LEDs 23 and have an arched cross-sectional shape. The recessed portions 45 are formed at random. The LEDs 23 are arranged on the vehicular exterior side with respect to the upper board 12. The LEDs 23 are divided into groups of the LED sets 24 each of which includes two LEDs 23 arranged next to each other at the interval L1 in the vehicular front-rear direction. The LED sets 24 are arranged in the vehicular front-rear direction at the interval L3 that is greater than the interval L1. The controller 50 is configured to control each of the LEDs 23 to turn on and off separately and configured to turn on the two LEDs 23 of one of the LED sets 24 at different timings.

According to such a configuration, an image is projected on the vehicular interior with light that is emitted by the LED sets 24 and passes through the light transmissive plate 40 having the recessed portions 45. Such an image is a flickering light image like flickering flame or aurora.

The controller 50 is configured to control the LEDs 23 such that the luminous intensity gradually increases after turning on and then gradually decreases to be off and control the two LEDs 23 of one of the LED sets 24 to be turned on at different timings so as to have a highest luminous intensity at different timings.

According to such a configuration, a natural and continuous flickering light image pattern can be obtained compared to the configuration of just turning on and off the LEDs.

The irradiation ranges of the LEDs 23 included in one of the LED sets 24 overlap. According to such a configuration, a natural and continuous flickering light image pattern can be obtained compared to the configuration in which the irradiation ranges of the LEDs included in one of the LED sets do not overlap.

The two LEDs 23 included in one of the LED sets 24 are disposed to opposite one of the recessed portions 45. According to such a configuration, an image pattern formed with one recessed portion 45 can be a clear flickering image.

### Other Embodiments

The technology described herein is not limited to the embodiments described above with reference to the drawings. The following embodiments may be included in the technical scope. The technology described herein may be modified within the technical scope.

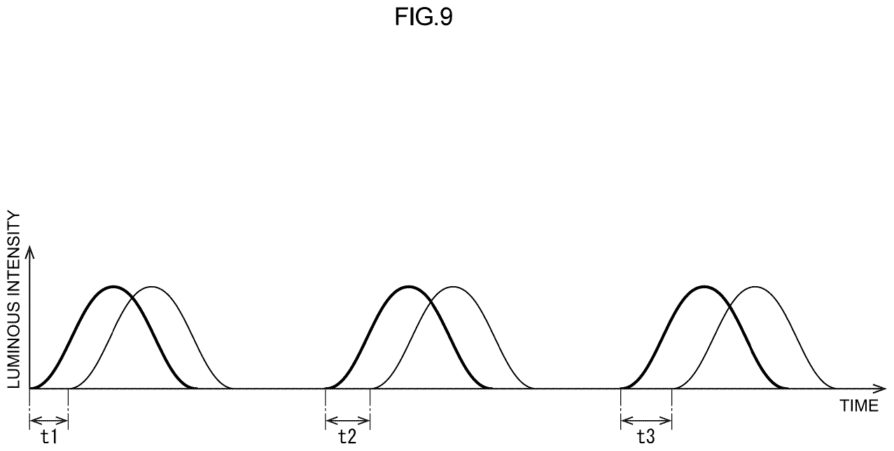

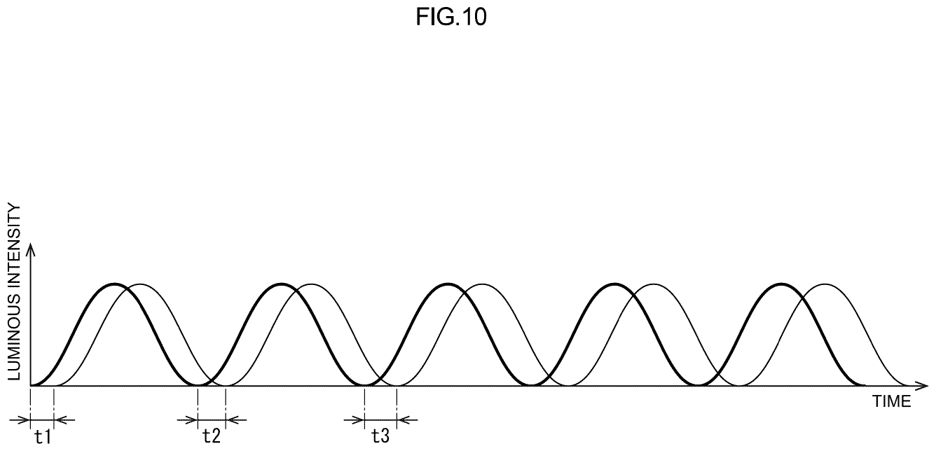

(1) In the above embodiment, the two LEDs 23 of one of the LED sets 24 are turned on at different timings with the luminous intensity change of a same waveform and a same time difference t1 of the different timings and such an operation is repeated intermittently or successively. However, the time difference of the timings when the two LEDs 23 included in each LED set 24 are turned on may be varied and a waveform of the luminous intensity change of the two LEDs 23 may be varied for each LED 23. For example, as illustrated in FIGS. 9 and 10, the time difference between the timings when the LEDs are turned on may be varied. Particularly, in FIGS. 9 and 10, the time difference increases from t1 to t3 (t1<t2<t3). The LEDs may have different luminous intensities (different heights of waveforms). The lighting device may have any configurations as long as the two LEDs included in one of the LEDs have different luminous intensities or different turning-on timings.

(2) In the above embodiment, each LED set 24 includes two LEDs 23; however, the LED set may include three LEDs. In such a configuration, the three LEDs of the LED set may be turned on at different timings and have a highest luminous intensity at different timings. Thus, a flickering image pattern is obtained.

(3) In the above embodiment, the controller 50 is configured to control the LEDs 23 such that the luminous intensity gradually increases after turning on and then gradually decreases to be off. However, the control or change of the luminous intensity of the LEDs may be varied as appropriate.

(4) The above embodiment includes the first LED board 22A and the second LED board 22B that face different directions. The LEDs 23 on the first LED board 22A and the LEDs 23 on the second LED board 22B emit light in different directions. However, the LEDs on the LED boards may emit in a same direction.

(5) In the above embodiment, the light transmissive plate 40 includes the recessed portions 45 having an arched cross-sectional shape on the vehicular exterior side surface. However, the light transmissive plate may include protruding portions having a semicircular cross-sectional shape on a vehicular interior side surface. Furthermore, the light transmissive plate may include recessed portions and protruding portions on a surface or a pattern on a surface.

(6) The two or three LEDs included in one LED set may be disposed opposite multiple lens portions.

(7) In the above embodiment, the distance L2 between the first LED set 24A and the second LED set 24B, which are adjacent to each other, is determined such that the irradiation ranges of the LED 23 included in the first LED set 24A and the LED 23 included in the second LED set 24B do not overlap when the light emitted by the LEDs 23 passes through the light transmissive plate 40. A distance between adjacent two LED sets may be determined such that the irradiation ranges of the LED included in the adjacent two LED overlap when the light emitted by the LEDs passes through the light transmissive plate.

(8) In the above embodiment, the lighting device 20 is mounted on the door trim 10 for a vehicle as a vehicular lighting device. However, the present technology may be applied to other vehicular interior components such as a pillar garnish, a ceiling member, a console box, a dashboard, various kinds of instrument panels, and a deck trim, and may be applied to interior components for trains, aircrafts, ships and also applied to a lighting structure mounted on members other than vehicular interior components.

1. A vehicular lighting device to be mounted on an interior component that includes an upper plate member extending in a vehicular front-rear direction and having an interior design surface and a lower plate member disposed below the upper plate member and on a vehicular exterior side with respect to the upper plate member, the vehicular lighting device comprising:
LEDs arranged on the vehicular exterior side with respect to the upper plate member, the LEDs being defined into LED sets each of which includes at least two LEDs arranged at a first interval in the vehicular front-rear direction and the LED sets being arranged in the vehicular front-rear direction at a second interval that is greater than the first interval, the LEDs emitting and supplying light to a vehicular interior space;
a light transmissive member that is disposed between a lower edge of the upper plate member and an upper edge of the lower plate member and has a plate shape having a plate surface extending in a vehicular interior-exterior direction and through which light from the LEDs passes toward the vehicular interior space, the light transmissive member including recessed portions on the plate surface facing the LEDs; and
a controller configured to turn on and off each of the LEDs separately and configured to turn on the at least two LEDs included in one of the LED sets at different timings.

2. The vehicular lighting device according to claim 1, wherein
the controller is configured to control the LEDs to gradually increase luminous intensity after turning on the LEDs and subsequently gradually decrease the luminous intensity and turn off, and
the controller is configured to turn on the at least two LEDs included in the one of the LED sets to have highest luminous intensity at different timings.

3. The vehicular lighting device according to claim 1, wherein irradiation ranges of the at least two LEDs included in the one of the LED sets overlap.

4. The vehicular lighting device according to claim 1, wherein the at least two LEDs included in the one of the LED sets are disposed opposite one of the recessed portions.

5. The vehicular lighting device according to claim 1, wherein optical axes of the at least two LEDs extend through one of the recessed portions.

6. The vehicular lighting device according to claim 1, wherein the light transmissive member is disposed below the LEDs and light emitting surfaces of the LEDs face the light transmissive member.
